(19) United States
(12) Patent Application Publication
(10) Pub. No.: US 2008/0291876 A1
(43) Pub. Date: Nov. 27, 2008

(54) PROTOCOL ARCHITECTURE FOR ACCESS MOBILITY IN WIRELESS COMMUNICATIONS

(75) Inventors: Rajat P. Mukherjee, Montreal (CA); Ulises Olvera-Hernandez, Kirkland (CA)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 12/126,243

(22) Filed: May 23, 2008

Related U.S. Application Data
(60) Provisional application No. 60/940,230, filed on May 25, 2007.

(51) Int. Cl. H04Q 7/20

(52) U.S. Cl. 370/331

(57) ABSTRACT

Access-independent mobility-enabling protocol messages are mapped into DIAMETER messages and communicated with peer entities using DIAMETER. Local access-independent mobility enabling protocol messages may also be communicated using DIAMETER. In one embodiment, the IEEE 802.21 media independent handover (MIH) protocol is the access-independent mobility-enabling protocol, and MIH messages are mapped into DIAMETER messages. IEEE 802.21 information elements (IEs) are transported over DIAMETER as attribute value pairs (AVPs). New DIAMETER Command Codes and Command flags may be defined to indicate message type. In another embodiment secure IP based transport and discovery and capability negotiation may be performed using an access-independent mobility enabling protocol (such as MIH) over DIAMETER.

### CROSS REFERENCE TO RELATED APPLICATIONS

This application claims the benefit of U.S. provisional application No. 60/940,230 filed on May 25, 2007, which is incorporated by reference as if fully set forth.

### BACKGROUND

The IEEE 802.21 standard defines mechanisms and procedures that aid in the execution and management of inter-system handovers. IEEE 802.21 defines three main services available to Mobility Management applications, such as Client Mobile Internet Protocol (Client MIP) or Proxy MIP. Referring to FIG. 1, these services are the Event Service 100, the Information Service 105 and the Command Service 110. These services aid in the management of handover operations, system discovery and system selection by providing information and triggers from lower layers 115 to upper layers 120 via a media independent handover (MIH) function (MIHF) 125.

Events may indicate changes in state and transmission behavior of the physical, data link and logical link layers, or warn about possible state changes of these layers. The Event Service may also be used to indicate management actions or command status on the part of the network or some management entity. The command service enables higher layers to control the physical, data link, and logical link layers (also known as “lower layers”). The higher layers may control the reconfiguration or selection of an appropriate link through a set of handover commands. If an MIHF supports the command service, all MIH commands are mandatory in nature. When an MIHF receives a command, it is always expected to execute the command. The Media Independent Information Service (MIIS) provides a framework and corresponding mechanisms by which an MIHF entity may discover and obtain network information existing within a geographical area to facilitate the handovers.

DIAMETER is an Internet Engineering Task Force (IETF) protocol used primarily for network authentication, authorization, and accounting (AAA). DIAMETER offers the following features: delivery of attribute value pairs (AVPs), capabilities negotiation, error notification, extensibility through addition of new commands and AVPs, security (Internet Protocol Security (IPSec) is mandatory in DIAMETER and Transport Layer Security (TLS) is optional), peer discovery and configuration via DNS, and support for inter-domain roaming. DIAMETER runs over Transmission Control Protocol (TCP) or Streaming Control Transmission Protocol (SCTP).

DIAMETER applications can extend the base protocol by adding new commands and/or attributes. A DIAMETER application is not a program, but a protocol based on DIAMETER. Referring to FIG. 2, the DIAMETER header 200 includes Command Flags 205, a Command Code field 210, an Application-ID field 215, and at least one attribute value pair (AVP) field 220. The Command Flags 205 indicate the characteristics of the following command. Different applications are identified by a unique Application-ID field 215, along with application specific Command Codes 210 and associated AVP data format(s) 220. New applications can reuse existing Command Codes 210 and AVPs 220 or define new ones. New Command Codes 210 and AVP data format(s) 220 are approved by Internet Assigned Numbers Authority (IANA).

Referring to FIG. 3, the Command Flags 205 is 8 bits and is used to indicate the characteristics of the following command defined in the Command Code field 210. The first bit position (bit 0) for the Command Flags 205 is the R (Request) bit. If set, the message is a request, otherwise the message is an answer. The second bit position (bit 1) of the Command Flags 205 is the P (Proxiable) bit. If set, the message may be proxied, relayed or redirected. If cleared, the message must be locally processed. The third bit position (bit 2) of the Command Flags 205 is the E (Error) bit. If set, the message contains a protocol error and the message will not conform to the augmented Backus-Naur form (ABNF) syntax described for this command. Messages with the E bit set are commonly referred to as error messages. This bit must not be set in request messages. The fourth bit position (bit 3) of the Command Flags 205 is the T (Potentially re-transmitted message) bit. This bit is set after a link failover procedure to aid the removal of duplicate requests. It is set when resending requests not yet acknowledged, as an indication of a possible duplicate due to a link failure. The T bit must be cleared when sending a request for the first time otherwise the sender must set this flag. DIAMETER agents that receive a request with the T flag set must keep the T flag set in the forwarded request. The T bit must not be set if an error answer message (for example a protocol error) has been received for the earlier message. The T bit is set only in cases where no answer has been received from a server for a request and the request retransmitted. The T bit must not be set in answer messages. The remaining bit positions (bits 4 through 7) are reserved. These flag bits are reserved for future use. They must be set to zero and ignored by the receiver.

Referring to FIG. 4, the DIAMETER AVP data format 220 includes an AVP Code 405, AVP Flags 410, AVP Length 415, an optional Vendor Identification (Vendor-ID) field 420, and an associated data field 425. Basic AVP data formats include octet string, integer (32 bit, 64 bit), float (32 bit or 64 bit), unsigned integer (32 bit or 64 bit), and grouped (sequence of AVPs). The AVP Length 415 is three octets and indicates the number of octets in this AVP 220 including the AVP Code 405, AVP Flags 410, AVP Length 415, Vendor-ID field 420 (if present), and the AVP data 425. If a message is received with an invalid attribute length, the message should be rejected.

Referring to FIG. 5, the AVP Flags 410 inform a receiver how each attribute must be handled. The V bit, known as the Vendor-Specific bit, indicates whether the optional Vendor-ID field is present in the AVP header. When set the AVP Code belongs to the specific vendor code address space. The M (Mandatory) bit indicates whether support of the AVP is required. If an AVP with the M bit set is received by a DIAMETER client, server, proxy, or translation agent and either the AVP or its value is unrecognized, the message must be rejected. DIAMETER relay and redirect agents must not reject messages with unrecognized AVPs. The P (Privacy) bit indicates the need for encryption for end-to-end security. The r (reserved) bits are unused and should be set to 0. Subsequent DIAMETER applications may define additional bits within the AVP Flags 410 and an unrecognized bit should be considered an error.

The IEEE 802.21 standard does not specify a mechanism for interaction with upper Internet protocol (IP) and transport layers (collectively higher layers). Due to the flexibility of DIAMETER, a DIAMETER based IEEE 802.21 application, supporting secure IP based transport, discovery and capability negotiation mechanisms, is desired.

### SUMMARY

Access-independent mobility-enabling protocol messages are mapped into DIAMETER messages and communicated with peer entities using DIAMETER. Local access-independent mobility enabling protocol messages may also be communicated using DIAMETER. In one embodiment, the IEEE 802.21 media independent handover (MIH) protocol is the access-independent mobility-enabling protocol, and MIH messages are mapped into DIAMETER messages. IEEE 802.21 information elements (IEs) are transported over DIAMETER as attribute value pairs (AVPs). New DIAMETER Command Codes and Command flags may be defined to indicate message type. In another embodiment secure IP based transport and discovery and capability negotiation may be performed using an access-independent mobility enabling protocol (such as MIH) over DIAMETER.

### BRIEF DESCRIPTION OF THE DRAWINGS

A more detailed understanding of the invention may be had from the following description, given by way of example and to be understood in conjunction with the accompanying drawings wherein:

FIG. 1 is an IEEE 802.21 protocol architecture according to the prior art;

FIG. 2 is a DIAMETER header message configuration according to the prior art;

FIG. 3 is a Command Flag field configuration of the DIAMETER header message of FIG. 2;

FIG. 4 is an AVP data format of the DIAMETER header message of FIG. 2;

FIG. 5 is an AVP Flags field configuration of the AVP data format of FIG. 4;

FIG. 6 is an IEEE 802.21 over DIAMETER protocol architecture as disclosed herein;

FIG. 7 is a second IEEE 802.21 over DIAMETER protocol architecture as disclosed herein;

FIG. 8 is a wide area network architecture of a WTRU communicating with multiple PoS in accordance with IEEE 802.21 over DIAMETER; and

FIG. 9 is a WTRU and access point configured to communicate using IEEE 802.21 over DIAMETER as disclosed herein.

### DETAILED DESCRIPTION

When referred to hereafter, the terminology “wireless transmit/receive unit (WTRU)” includes but is not limited to a mobile node, a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “access point” includes but is not limited to a Node-B, a site controller, a base station, or any other type of interfacing device capable of operating in a wireless environment.

The embodiments disclosed herein are directed toward a DIAMETER-based protocol for exchanging information for access-independent mobility-enabling protocols, such as the IEEE 802.21 Media Independent Handover standard. In one embodiment IEEE 802.21 peers are discovered using a DIAMETER-based protocol. In another embodiment, IEEE 802.21 messaging is carried over DIAMETER based signaling to allow for exchange of information, events and commands between a mobile client (for example a WTRU) and an anchor point (for example a MIH server (MIHS)) for control and user plane signaling.

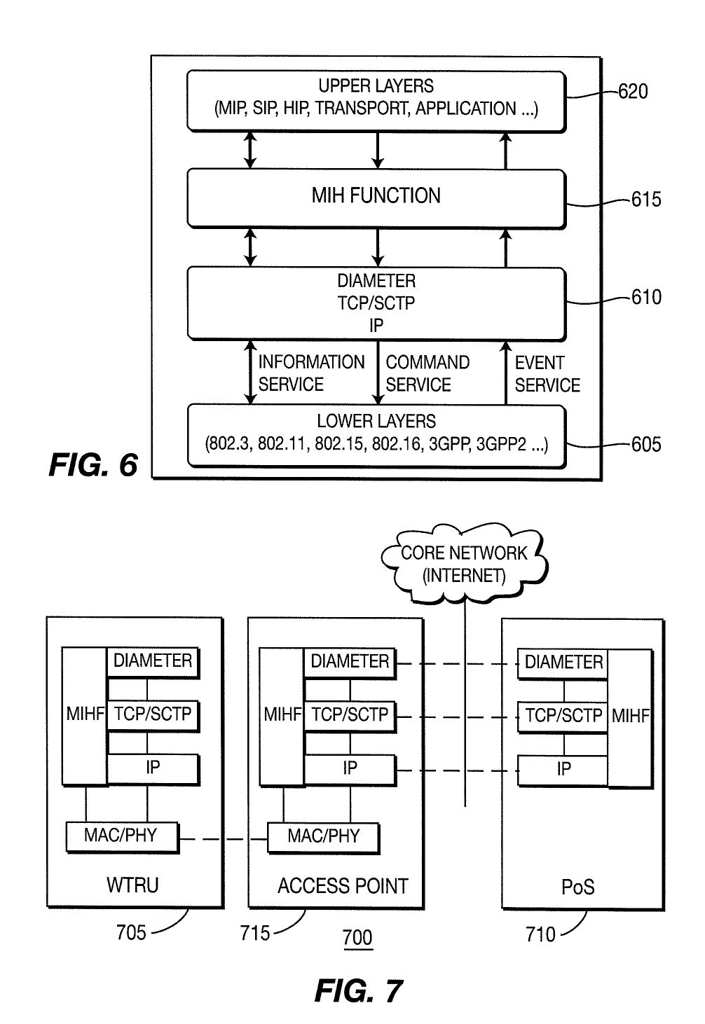

The 802.21 over DIAMETER signaling effectively moves the MIH layer higher up in the protocol architecture by transporting MIH messages as a DIAMETER application. Referring to FIG. 6, an IEEE 802.21 over DIAMETER protocol architecture includes lower layers 605, a DIAMETER, TCP/SCTP, and IP layer 610, an MIH Function 615, and upper layers 620.

IEEE 802.21 information, event, and command services messaging is carried in new DIAMETER AVPs and Command Codes. These IEEE 802.21 messages may include capability negotiation and discovery as well as any other messaging. The DIAMETER protocol meets the requirements of IEEE 802.21 with regards to an upper layer transport protocol as it provides security (IPsec is mandatory in DIAMETER while TLS is optional) and, since it uses TCP or SCTP as the transport layer protocol, reliability and NAT traversal is also guaranteed. Further, the DIAMETER protocol is fully compatible with IPv4 or IPv6.

Referring to FIG. 7, a protocol stack architecture 700 of IEEE 802.21 over DIAMETER allows a WTRU 705 to communicate with a point of service (PoS) 710 independent of radio access technology. WTRU 705 communicates with an access point 715 using a technology specific medium access control (MAC) and physical (PHY) layer protocol MAC/PHY (for example 802.16, 802.11x, 802.15, Global System for Mobile Communication (GSM), Universal Mobile Telecommunication System (UMTS), CDMA2000, and the like). A MIHF layer, DIAMETER layer, TCP/SCTP layer, and an IP layer exist in WTRU 705, Access Point 715, and PoS 710. MIHF messaging is communicated between the WTRU 705, Access Point 715, and PoS 710 over DIAMETER protocol messaging.

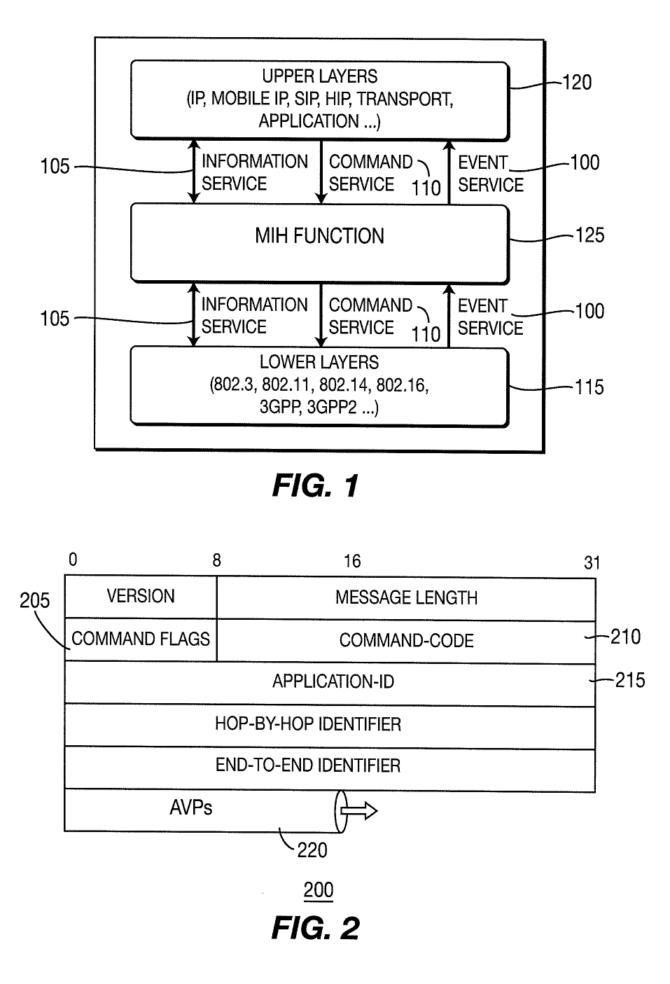

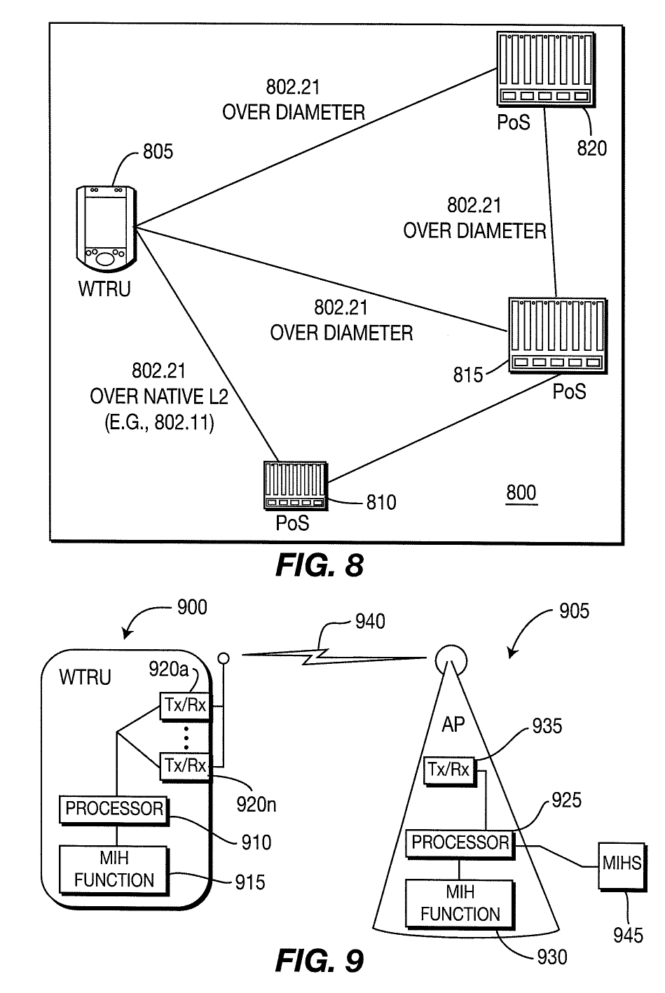

Depending on the wide area network architecture, the IEEE 802.21 protocol may run over the native MAC/PHY layer (based on the general protocol architecture described above with reference to FIG. 1) or over DIAMETER as shown above with reference to FIG. 6. Referring to FIG. 8, a diverse wide area network 800 includes a WTRU 805 in communication with three PoS 810, 815, and 820. WTRU 805 communicates with PoS 810 via IEEE 802.11n MAC/PHY protocols, purely for example. IEEE 802.21 operates over the IEEE 802.11n MAC/PHY layer 2 protocols, as described above with reference to FIG. 1. WTRU 805 communicates with PoS 815 and 820 using various MAC/PHY layer 2 protocols while IEEE 802.21 protocol operates over DIAMETER, as described above. PoS 815 and 820 may also use IEEE 802.21 protocols over DIAMETER to communicate with each other.

When the IEEE 802.21 protocol is implemented over DIAMETER, DIAMETER features such as Discovery of DIAMETER peers and Capability Negotiation can be used to enhance or replace equivalent mechanisms in IEEE 802.21. In one embodiment, DIAMETER is used to discover MIH peers and their capability. The discovery of DIAMETER peers might be achieved, for example, by encoding the Internet Protocol (IP) address and the Fully Qualified Domain Name (FQDN) of the MIH peer as a DIAMETER AVP. The capability negotiation may indicate the service provided by the MIH peer (for example, Information Service only, Event service only, and so on).

In another embodiment, all IEEE 802.21 messages between local MIHF located in a WTRU and remote MIHF located in a PoS are mapped to new Command Codes in the DIAMETER header. All information elements (IEs) in those messages are mapped to new AVPs of an appropriate data type. In the event that existing DIAMETER-based implementations have Command Codes/AVPs serving the same functionality and having appropriate characteristics (e.g. number of octets, etc.) they may be reused for IEEE 802.21 purposes. Further, certain MIH IEs that are sent in all MIH messages (for example, an MIH Header IE) may be considered a collection of IEs, each with its own distinct DIAMETER AVP. These AVPs may be collected into “Grouped AVPs”.

Purely for example, Table 1 below shows MIH messages and possible DIAMETER counterparts. A new Command Code may be obtained for each of the messages defined above as well as any other MIH Messages that may be sent using DIAMETER.

TABLE 1

| | | Command |
|---|---|---|
| MIH Message | DIAMETER Message | Flags |
| MIH Registration Request | MIH Registration Request | R, P |
| MIH Registration Response | MIH Registration Response | P |
| MIH Event Subscription | MIH Event Subscription | R, P |
| Request | Request | |
| MIH Event Subscription | MIH Event Subscription | P |
| Response | Response | |
| MIH Command Request | MIH Command Request | R, P |
| MIH Command Response | MIH Command Response | P |

The IEs of these messages as defined in the IEEE 802.21 protocol may be encapsulated as DIAMETER AVPs. As an example, IEEE 802.21 identifies ‘TYPE_IE_COST’ as an access network specific IE. TYPE_IE_COST has a length of 10 octets as defined in IEEE 802.21. The AVP field described above with reference to FIG. 4 is set accordingly. AVP flags are determined, AVP Length is defined (in this case 10 octets plus overhead), an optional Vendor-IR field is added if desired, and the TYPE_IE_COST IE is included in the AVP data portion. As another example, IEEE 802.21 identifies the IE MIHF-ID as the identifier that is required to uniquely identify MIHF end points for delivering the MIH services. This MIHF-ID may be the FQDN or the NAI of the sender. The content of the MIHF-ID (e.g. FQDN of the MIHF entity) may be encoded as a DIAMETER AVP.

In the above mentioned embodiments, DIAMETER is used as a transport mechanism for message transfer between MIH peers (for example, an MIH peer in a WTRU and an MIH peer in a PoS) and for discovery of MIH peers. In another embodiment, IEEE 802.21 over DIAMETER is used as a transport mechanism for local messages and IEs (including, for example, lower layer MIH triggers included in the MIH Command Service). IEEE 802.21 over DIAMETER may of course be implemented for both MIH peer message transfer as well as for local MIH message transfer.

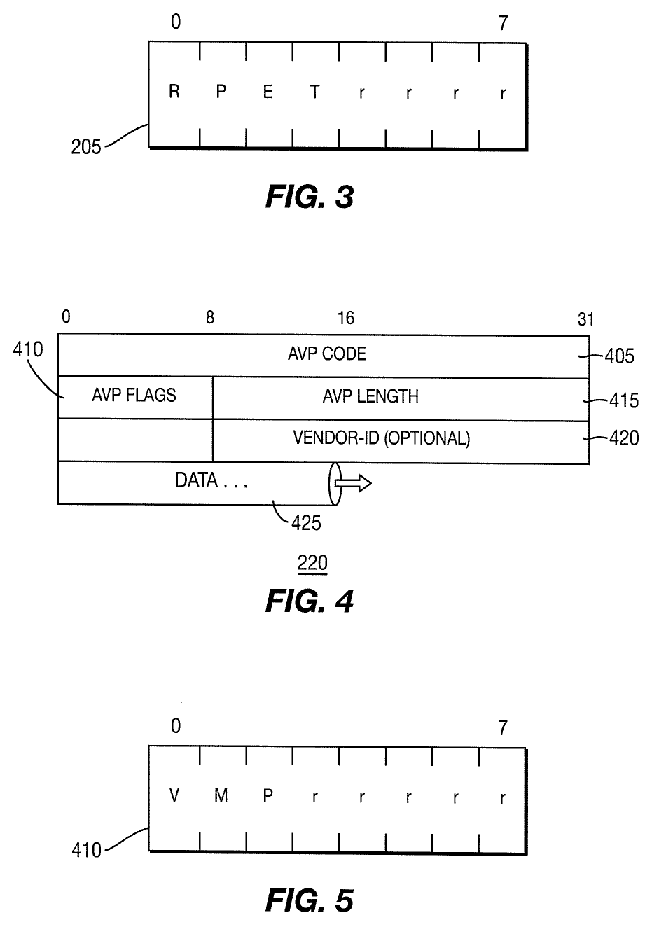

FIG. 9 is a WTRU 900 and access point 905 configured to implement the IEEE 802.21 protocol over DIAMETER as described above. WTRU 900 includes a processor 910, an MIH function 915, and a plurality of transceivers 920a . . . 920n, each configured to operate using a different radio access technology and protocol. The processor 910 and MIH function 915 are configured to operate protocol stacks according to the above described embodiments, particularly those described above with reference to FIGS. 1, 6, and 7. Further, the Processor 910 and MIH function 915 are capable of generating DIAMETER messages as described above with reference to FIGS. 2 and 3 and AVPs as described above with reference to FIGS. 4 and 5. The processor 910 and MIH function 915 are further configured to implement IEEE 802.21 protocols over DIAMETER for MIH peer messaging and to use DIAMETER for the discovery of other 802.21 peers, as an example, an 802.21 server providing 802.21 based Information Services can be found using DIAMETER discovery functions. The IEEE 802.21 over DIAMETER messages may be transmitted to MIH peers via any of the plurality of transceivers 920a . . . 920n. The processor 910 and MIH function 915 are further configured to implement local IEEE 802.21 over DIAMETER messaging, for example for the IEEE 802.21 Command service. The transformation of MIH message into DIAMETER messages, and the extraction of MIH messages from received DIAMETER messages may be performed by either processor 910 or MIH function 915, or by a combination of the two.

Access point 905 includes a processor 925, an MIH function 930, and a transceiver 935. The access point 905 communicates with WTRU 900 via air interface 940. The processor 925 of the access point 905 processes received IEEE 802.21 over DIAMETER messages received from WTRU 900 via transceiver 935. The processor 925 and MIH function 930 of the access point 905 are further capable of generating DIAMETER messages as described above with reference to FIGS. 2 and 3 and AVPs as described above with reference to FIGS. 4 and 5. The processor 925 and MIH function 930 are further configured to implement IEEE 802.21 protocols over DIAMETER for MIH peer messaging, such as messaging between the access point 905 and an MIH server (MIHS) 945, or a PoS (not shown). The transformation of MIH message into DIAMETER messages, and the extraction of MIH messages from received DIAMETER messages may be performed by either processor 925 or MIH function 930, or by a combination of the two.

While the above mentioned disclosure and embodiments primarily focused on the IEEE 802.21 protocol implemented over DIAMETER, it is apparent to those skilled in the art that any access independent protocol may be operated over DIAMETER. The focus on IEEE 802.21 is merely exemplary and is not intended to limit the scope of this disclosure in any manner. MIH capabilities may be provided without using the IEEE 802.21 protocol. In this case, DIAMETER features (such as Discovery of peers and capability notification) are still used. As an example, a WTRU may use DIAMETER to discover an entity capable of providing it with a MIH information service. The MIH information service provided may be similar to that provided by the IEEE 802.21 protocol.

Although the features and elements of the present invention are described in the preferred embodiments in particular combinations, each feature or element can be used alone without the other features and elements of the preferred embodiments or in various combinations with or without other features and elements of the present invention. The methods or flow charts provided in the present invention may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A wireless transmit/receive unit (WTRU) comprising:
a processor configured to operate a protocol stack including a media independent handover (MIH) protocol layer and a DIAMETER protocol layer, and to transform an MIH message into a DIAMETER message; and
a transmitter configured to transmit the DIAMETER message.

2. The WTRU of claim 1, further comprising:
an MIH function configured to extract an MIH message from a received DIAMETER transformed MIH message, and to perform MIH functions based on the extracted MIH message.

3. The WTRU of claim 1, wherein the processor is configured to transform the MIH message into a DIAMETER attribute value pair (AVP).

4. The WTRU of claim 3, wherein the MIH message includes a plurality of information elements (IEs) and the plurality of IEs are transformed as grouped AVPs.

5. A method for use in a wireless transmit/receive unit (WTRU), the method comprising:
creating a media independent handover (MIH) message;
transforming the MIH message into a DIAMETER protocol message; and
transmitting the DIAMETER protocol message to a peer entity.

6. The method of claim 5, further comprising:
receiving a DIAMETER message containing a transformed MIH message;
extracting the transformed MIH message from the received DIAMETER message; and
performing MIH functions based on the extracted MIH message.

7. The method of claim 5, wherein transforming the MIH message into a DIAMETER protocol message includes transforming the MIH message into a DIAMETER attribute value pair (AVP).

8. The method of claim 5, wherein the MIH message includes a plurality of information elements (IEs), and the transforming the MIH message into a DIAMETER protocol message includes transforming the plurality of IEs as grouped AVPs.

9. The method of claim 5, wherein transforming the MIH message into a DIAMETER protocol message includes authenticating and encrypting using IP security mechanisms.

10. A wireless transmit/receive unit (WTRU) comprising:
a processor configured to operate a protocol stack including an access-independent mobility-enabling protocol layer and a DIAMETER protocol layer, and to discover a peer entity of the access independent mobility-enabling protocol layer using the DIAMETER protocol layer.

11. The WTRU of claim 10, wherein the access-independent mobility-enabling protocol layer provides at least one of an information service, an event service, and a command service.

12. The WTRU of claim 11, wherein the information service facilitates an exchange of information relating to at least one of available access technologies, and location information.

13. The WTRU of claim 11, wherein the event service facilitates an exchange of information relating to at least one of availability of a new access link, and a measurement report.

14. The WTRU of claim 11, wherein the command service provides an indication to perform handover to a different access.

15. The WTRU of claim 10, wherein the access-independent mobility-enabling protocol is IEEE 802.21.

16. The WTRU of claim 10, wherein the DIAMETER protocol layer provides a Fully Qualified Domain Name (FQDN) of a discovered peer entity to the access-independent mobility-enabling protocol.

17. The WTRU of claim 16, wherein the FQDN is encoded as a DIAMETER attribute value pair (AVP).

18. The WTRU of claim 11, wherein the DIAMETER protocol layer provides information that facilitates discovery of peer entity capabilities by the access-independent mobility enabling protocol.

19. The WTRU of claim 18, wherein the information is encoded as a DIAMETER attribute value pair.
